(19) United States
(12) Patent Application Publication
(10) Pub. No.: US 2020/0140630 A1
(43) Pub. Date: May 7, 2020

(54) Advanced Silicate Fiber Polymer Composite

(71) Applicant: Tundra Composites, LLC, White Bear Lake, MN (US)

(72) Inventors: Adam Bartel, St. Paul, MN (US); Scott Bohnen, Stillwater, MN (US); Kurt Heikkila, Marine on the Saint Croix, MN (US)

(73) Assignee: Tundra Composites, White Bear Lake, MN (US)

(21) Appl. No.: 16/547,913

(22) Filed: Aug. 22, 2019

Related U.S. Application Data
(60) Provisional application No. 62/755,774, filed on Nov. 5, 2018.

(51) Int. Cl. C08J 5/04; C08L 97/02

(52) U.S. Cl. CPC C08J 5/044; C08J 2497/02; C08J 2327/06; C08L 97/02

(57) ABSTRACT

Disclosed is a particulate combined with a silicate in a discontinuous phase dispersed in a continuous polymer phase in a composite having enhanced properties.

### CROSS-REFERENCE TO RELATED APPLICATIONS

This application claims the benefit of a U.S. Patent Provisional Application Ser. No. 62/755,774, filed Nov. 5, 2018. This application is hereby incorporated by reference in its entirety

### FIELD

Disclosed is a polymer composite of a silicate fiber and a particulate. The advanced composite has improved processing characteristics, improved structural product properties that produce enhanced products. The novel properties are produced in the composite by novel interactions of the dispersed components and polymer components in the composite.

### BACKGROUND

Blended materials have been made for many years by combining generally two or more dis-similar materials to obtain beneficial properties from the combination. In a true composite, the interactions of the component materials provide the best properties and characteristics of both components. The use of a reinforcing materials produces a range of materials and, under the correct conditions, can form a true polymer composite. In contrast, a simple filled polymer, following the rule of mixtures, with additives or fillers, displays properties that are simply expected based on the nature of the materials. Fillers are often used as simple replacements for a more expensive component to reduce costs in the composition. Strongly coupled materials, such as bonded polymer to fiber or fiber to fiber, have minimal viscoelastic properties.

Substantial attention has been paid to the creation of composite materials with unique properties. Particulate, fiber and fabric reinforced polymer materials can include metal and inorganic materials, cellulosic fiber, high modulus polyolefin fiber, polybenzoxazole fiber, carbon fiber, aramid fiber, boron fiber, glass fiber and hybrid materials. The fiber can be used in reinforcing thermoplastics and thermosets. Polyolefin, polyvinyl chloride (PVC) and other thermoplastics and hybrids have been developed for a variety of end uses. Epoxy and polyurethane thermosets are common.

Developing thermoplastic composite materials have faced difficult barriers. To obtain successful thermal processing, and physical properties such as significant tensile, modulus, impact and coefficient of thermal expansion (COTE) properties, composites need control the degree component concentration and the interaction between reinforcing particles or fiber and polymer and the degree of loading in the polymer matrix. High concentration polymer composite materials cannot be easily made. Melt processing thermoplastics and particles and fibers are not easily combined due to differences in the polymer with respect to particles and fiber character such as composition, density, surface energy, roughness and fiber morphology. Excessive compounding processing needed to obtain a uniform composite can cause fiber damage and thermal depolymerization of the polymer with accompanying hazards of fire and toxic gasses. While composites have been proposed with high dispersed loadings, commercially, due to process limitations, products have typically achieved about 40-50 vol. % dispersed phases in composite materials.

While a substantial amount of work has been done regarding reinforced thermoplastic polymer composite materials. A substantial need exists for a composite material that has a dispersed phase of particles or fiber having a dispersed surface that is made more compatible and inert with respect to the polymer, improved packing efficiency and with high dispersed or discontinuous phase content, improved thermal compounding processing that maintains dispersed phase integrity with improved rheology, and produce composites with improved structural properties at elevated use temperatures.

### BRIEF DESCRIPTION

A polymer composite of an interfacially modified dispersed phase of silicate fiber and a particulate such as a silica particulate. The combined silicate fiber and particle has improved and novel properties. The claimed composite is made of a combination of a thermoplastic polymer and discontinuous phase of a combination of a silicate fiber and particulate, each modified with a coating of an interfacial modifier (IM). The composite can be made of about 10 to 90 wt. % of a continuous phase comprising the polymer with about 90 to 10 wt. % of a discontinuous phase. The composite properties result from a selection of particle, length, diameter and aspect ratio, polymer type, molecular weight, viscoelastic character and processing conditions. The resulting composite materials exceed the contemporary structural composites in at least one property such as packing, surface inertness, processability, COTE, tensile properties modulus and physical modulus. Such a composite material is a thermoplastic in character and can be extruded and then melted and reextruded. The composite can be formed, and a pellet and the pellet can be formed into a useful product with melt processing techniques. Useful volume % of the dispersed phase in the claimed composite can be adjusted to above 40, 50, 60, 70, 80, or 90%, depending on the end use of the article or structural member and the required physical properties of the article or structural member, without loss of processability via melt-processing, viscoelasticity, rheology, high packing fraction, and fiber surface inertness of the composite.

One aspect of the claimed material is a composite of interfacially modified fiber and particulate blend and polymer. Either the particles or fibers can be densified. Such a composite material is a thermoplastic in character and can be extruded and then melted and reextruded.

One aspect of the claimed material is a composite of interfacially modified silicate fiber and glass microspheres and polymer. Either fiber or glass can be densified. Such a composite material is a thermoplastic in character and can be extruded and then melted and reextruded.

One aspect of the claimed material is a composite of interfacially modified silicate fiber and an inorganic particulate such as a glass bead or hollow glass sphere and polymer. Either the particles or fibers can be densified. Such a composite material is a thermoplastic in character and can be extruded and then melted and reextruded.

One aspect of the claimed material is a composite of interfacially modified wollastonite fiber and an inorganic particulate in a blend with polymer. Either the particles or fibers can be densified. Such a composite material is a thermoplastic in character and can be extruded and then melted and reextruded.

Still another aspect is a pellet made of the composite that can be used as an intermediate article between the compounding of the composite and the manufacturing of the final product. Such a pellet can comprise the composite comprising the components designed to be directly used in making an article. Alternatively, the pellet can comprise a master batch composition with increased amounts of dispersed phase such that the pellet can be combined with polymer in proportions that result in producing use concentrations.

Another aspect is a structural member made of the composite. Such structural members can be used in commercial and residential construction and can include siding and fenestration units including decking, trim, windows and doors.

A final aspect of the claimed material is a method of compounding the composite by compounding the combined polymer resin and interfacial modified particulate or fiber under thermoplastic conditions.

The term a “phase” is a region in which the physical and chemical properties of the contained material are substantially the same. As used in this disclosure the term “continuous phase” means the polymer matrix into which the particulate or fiber is dispersed during compounding. The term “discontinuous phase” also “dispersed phase” means the individual particles or fibers that are dispersed throughout the continuous phase.

A “fiber” means a collection of similar fibers in a fibrous material combined with a polymer as input to a compounding process unit. Fiber typically have an aspect ratio greater than 1:3 or 1:3 and often greater than 1:20, 1:40, 1:100, etc. Fiber as used in a discontinuous phase can be free of a particle or particulate.

The term “particulate” means a collection of similar particles. Particles are objects less than 500 microns with an aspect ratio less than 1:3.

Particle, or a collection of particles known as a particulate, is a discrete object having a particle size about 0.1-500 microns, an aspect ratio of less than 3, and a circularity ((circularity, is measured by a view of the two-dimensional projection of a particle and is equal to (perimeter)²/area)) is less than 20. The non-circular rough or ragged morphology provides the reinforcement in combination with the fiber. More circular materials provide lesser reinforcement. The more the material departs from the near circular and obtains an irregular morphology, the more reinforcement is obtained in the resulting composite. The particulate be inorganic, metallic, glass, ceramic or mineral?

Silica (SiO₂) is not a silicate. Silica typically comprised most of individual species as SiO₂ or SiO₂ combinations. A silicate typically comprised most of individual species as a salt of a charged anionic species as silicate such as SiO₃⁻² or SiO₄⁻⁴ or other charged similar silicate or meta silicate species.

The term “interfacial modifier” (IM) means a material that can coat the surface of any part of the discontinuous phase such as particulate or fiber and does not react or interact with the polymer or other coated fiber present in the composite. In one embodiment, the IM is an organo-metallic compound.

The term “densified’ when used as a composite material characteristic means a particulate or fiber source that is processed to increase the bulk density of the material such that is approaches the density of the polymer used in the composite. A silicate fiber that is naturally about 0.2 to 0.4 g·cm⁻³ density is processed to be at least 0.5 or 0.7 g·cm⁻³.

### DETAILED DISCUSSION

Novel composites are made by combining an interfacial modified dispersed particle phase blend and a polymer to achieve novel physical and process properties. The dispersed phase blend comprises a silicate particulate and optionally a second particulate or a fiber.

The fiber can comprise a metal (e.g., calcium or magnesium) silicate or meta silicate fiber through a reaction of a metal oxide with silica. While silicate chemistry is often complex, with varied propositions and crystal forms of metal oxide and silica. For example, calcium silicate can be expressed as CaSiO₃, Ca₂SiO₄ or 2CaO.SiO₂. A useful silicate fiber is wollastonite, a unique natural silicate (CaSiO₃) fiber containing small amounts of iron, magnesium and manganese. One aspect of the mineral can be represented as compositions including CaSiO₃—MgSiO₃—FeSiO₃ with the iron and magnesium components in minor proportions. Wollastonite is a crystalline fiber with chains of linked negatively charged SiO₄ tetrahedra.

Wollastonite is commonly used in ceramics, tiles, paints compositions. Wollastonite has been proposed as a substitute for asbestos in a variety of products but its unique inorganic nature has limited its applicability in thermoplastic composites. The morphology, roughness, surface energy and hydrophobic nature of the wollastonite fiber uncoated surface severely limits commercial manufacture due to resulting poor melt polymer mixing, minimal packing and nonuniform composites. The use of a densified material can increase the process characteristics of the material and obtain improved product uniformity and physical properties. Without a uniform composite, the compounding processing and resulting mechanical properties can be lacking. Each of the individual fibers of the generic, useful fiber material has a cross-section dimension (preferably but not limited to a diameter) of at least about 0.8 micron often about 1-150 microns and can be 2-100 microns, or 5 to 10 microns, a length of 0.1-150 mm, often 0.2-100 mm, and often 50 to 100 mm and can have an aspect ratio of at least 50 often about 100-1500. These aspect ratios are typical of the input into the compounder. After pellets are formed the aspect ratio is limited by the pellet dimensions.

A useful fiber is a wollastonite fiber as follows:

| Typical Properties: | VANSIL WG | | VANSIL HR-2000 | | VANSIL HR-1500 | |
|---|---|---|---|---|---|---|
| Density | 21.7 | lbs.-gal⁻¹ | 2 3.7 | lbs.-gal⁻¹ | 21.7 | lbs.-gal⁻¹ |
| | 2.9 | g-cc⁻¹ | 2.9 | g-cc⁻¹ | 2.9 | g-cc⁻¹ |
| pH. 10% slurry | 10-11 | | 10-11 | | 10-11 | |
| (ASTM D 1208) | | | | | | |
| G. E. Brightness | 86-88 | | 93-95 | | 93-95 | |
| (TAPPI T-646) | | | | | | |
| Bulk Density (loose) | 31 | lbs.-ft⁻³ | 25 | lbs.-ft ⁻³ | 24 | lbs.-ft⁻³ |
| Bulk Density (tapped) | 45 | lbs.-ft⁻³ | 39 | lbs.-ft⁻³ | 37 | lbs.-ft⁻³ |
| Average Aspect Ratio | 15:1 | | 12:1 | | 14:1 | |
| Average Needle Length | 90 | μm | 65 | μm | 60 | μm |
| Average Needle Width | 9 | μm | 7 | μm | 5 | μm |
| Particle Size (Horiba LA-300): | | | | | | |
| D10 | 4 | μm | 4 | μm | 3 | μm |
| D50 | 28 | μm | 17 | μm | 13 | μm |
| D90 | 117 | μm | 65 | μm | 50 | μm |
| D95 | 146 | μm | 88 | μm | 68 | μm |

| | | | |
|---|---|---|---|
| Wet Screen Analysis: | | | |
| The first Plus 100 mesh | <2% | 0.1% | <0.1% |
| Plus 200 mesh | 15-20% | <3% | <1% |
| Plus 325 mesh | 30-35% | <20% | 5-7% |

The particulate is a powdered or granular material typically less than about 500 microns and a limited aspect ratio and can comprise an inorganic or organic composition.

In an embodiment the silicate fiber is a wollastonite fiber.

The composite can be made of about 10 to 90 wt. % of a continuous phase comprising the polymer with about 5 to 95 wt. % or about 90 to 10 wt. % of a discontinuous phase. The discontinuous phase comprises a silicate fiber and a different fiber or a particulate.

The blend comprises up to about 90 wt. % of silica wollastonite fibers and 8 to 50 wt. % of another fiber such as an organic or inorganic fiber.

The blend comprises up to about 90 wt. % of silica wollastonite fibers and 8 to 50 wt. % of a particulate such as a glass sphere or metal silicate such as a calcium silicate or magnesium metasilicate. Silicate chemistry is often complex, with varied proportions and crystal forms of a reaction product of metal oxide and silica. Useful silicates include alkali metal and alkaline earth metal silicates. For example, calcium silicate or calcium metasilicate can be expressed as CaSiO₃, Ca₂SiO₄, CaO.SiO₂ or 2CaO.SiO₂.

A composite is more than a simple admixture with properties that can be predicted by the rule of mixtures. A composite is defined as a combination of two or more substances at various percentages, in which each component results in properties of the composite material that are in addition to or superior to those of its constituents. In a simple admixture, the mixed material has little interaction and little property enhancement. In a composite material, at least one of the materials is chosen to increase stiffness, strength or density.

The atoms and molecules in the components of the composite can form bonds with other atoms or molecules using several mechanisms. Such bonding can occur between the electron cloud of an atom or molecular surfaces including molecular-molecular interactions, atom-molecular interactions and atom-atom interactions. Each bonding mechanism involves characteristic forces and dimensions between the atomic centers even in molecular interactions. The important aspect of such bonding force is strength and the variation of bonding strength over distance and directionality. The major forces in the composites are limited van der Waals' (VDW) types of bonding.

The varied types of van der Waals' forces are different than covalent and ionic bonding. These van der Waals' forces tend to be forces between molecules, not between atomic centers. In the composites of the claimed materials strong covalent or ionic bonding is avoided. Reactive couplers that bond polymer to any component of the discontinuous phase are not used. The composite is formed with van der Waals bonding as modified by the IM coating.

The van der Waals' force, existing between substantially non-polar uncharged molecules occurs in non-polar molecules, arises from the movement of electrons within the molecule. Because of the rapidity of motion within the electron cloud, the non-polar molecule attains a small but meaningful instantaneous charge as electron movement causes a temporary change in the polarization of the molecule. These minor fluctuations in charge result in the dispersion portion of the van der Waals' force.

Such VDW forces, because of the nature of the fluctuating polarization of the molecule, tend to be low in bond strength, typically 50 kJ mol⁻¹, 30 kJ mol⁻¹ or less. Further, the range at which the force becomes attractive is also substantially greater than ionic or covalent bonding and tends to be about 3-10 Å.

In the interfacial modifier (IM) modified van der Waals composite materials, we have found that the unique combination of dispersed phase, the varying but controlled size and aspect ratio of the particulate and fiber component, the modification of the interaction between the particulate and fiber and the polymer, result in the creation of a unique van der Waals' association but no strong bonding. The van der Waals' forces arise between atoms/molecules/aggregates/crystals and are created by the combination of sizes, polymer and interfacial modifiers in the composite.

In the past, reference materials have been made as mere mixtures of components or as strongly covalently coupled components. While these are often characterized, as “composite”, they are stiff inextensible materials or merely comprised a polymer filled with particulate with little or no van der Waals' interaction between the particulate filler material. In sharp contrast to the previous materials, the interaction between the selection of dispersed phase, size distribution and interfacially modifier enables the composite to achieve an intermolecular distance that creates a substantial van der Waals' bonding.

The reference materials having little viscoelastic properties, do not achieve a true composite structure as is now described. This leads us to conclude that the proper association of dispersed phase and polymer such as this intermolecular distance is not attained in the reference materials. In the discussion above, the term “molecule” can be used to relate to a non-metal crystal or an amorphous aggregate, other molecular or atomic units or sub-units of non-metal or inorganic mixtures.

This characterized by a composite having intermolecular forces between particles and fibers of less than about 50 or 30 kJ-mol⁻¹ and a bond dimension of 3-10 Å. In the composite, the reinforcement, is usually much stronger and stiffer than the polymer matrix, and gives the composite its good properties in, for example a shaped article, structural member or other end use. The polymer matrix holds the reinforcements in an orderly high-density pattern. Because the reinforcements are usually discontinuous, the matrix also helps to transfer load among the reinforcements. Processing can aid in the mixing and filling of the reinforcement or fiber. To aid in the mixture, an interfacial modifier can help to overcome the forces that prevent the matrix from forming a substantially continuous phase in the composite. The composite properties arise from the intimate association of interfacially modified phase and polymer obtained by use of careful processing and manufacture.

The blend is typically coated with an interfacial surface chemical treatment also called an interfacial modifier (IM) that supports or enhances the final properties of the composite such as viscoelasticity, rheology, high packing fraction, and surface inertness due to the coating. These properties are not present in contemporary composite materials with no IM. The materials can be coated separately or can be combined and then coated. A substantially complete coating of an interfacial modifier (IM) with a thickness of less than 1500 Angstroms often less than 200 Angstroms, and commonly 10 to 500 Angstroms (Å) or 100 to 1500 Angstroms (Å).

An interfacial modifier can be an organo-metallic material that provides an exterior coating on a surface of the dispersed phase promoting the close association, but not attachment or bonding, of polymer to the dispersed phase. The composite properties arise from the intimate association of the polymer and dispersed phase obtained by use of careful processing and manufacture. An interfacial modifier is an organic material, in some examples an organo-metallic material, that provides an exterior coating on the dispersed phase to provide a surface that can associate with the polymer promoting the close association of polymer and dispersed phase but with no reactive bonding, such as covalent bonding for example, of polymer to dispersed phase, fiber to fiber, or fiber to a different particulate, such as a glass fiber or a glass bubble. The lack of reactive bonding between the components of the composite leads to the formation of the novel composite—such as high packing fraction, commercially useful rheology, viscoelastic properties, and surface inertness of the fiber. These characteristics can be readily observed when the composite with interfacially modified coated dispersed phase is compared to a dispersed phase lacking the interfacial modifier coating or is reactively coupled. In one embodiment, the coating of interfacial modifier at least partially covers the surface of the dispersed phase. In another embodiment, the coating of interfacial modifier continuously and uniformly covers the surface of the dispersed phase, in a continuous coating phase layer.

Interfacial modifiers used in the application fall into broad categories including, for example, titanate compounds, zirconate compounds, hafnium compounds, samarium compounds, strontium compounds, neodymium compounds, yttrium compounds, phosphonate compounds, aluminate compounds and zinc compounds. Aluminates, phosphonates, titanates and zirconates that are useful contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen and sulfur In one embodiment, the interfacial modifier that can be used is a type of organo-metallic material such as organo-cobalt, organo-iron, organo-nickel, organo-titanate, organo-aluminate organo-strontium, organo-neodymium, organo-yttrium, organo-zinc or organo-zirconate. The specific type of organo-titanate, organo-aluminates, organo-strontium, organo-neodymium, organo-yttrium, organo-zirconates which can be used, and which can be referred to as organo-metallic compounds are distinguished by the presence of at least one hydrolysable group and at least one organic moiety. Mixtures of the organo-metallic materials may be used. The mixture of the interfacial modifiers may be applied inter- or intra-fiber, which means at least one fiber may has more than one interfacial modifier coating the surface (intra), or more than one interfacial modifier coating may be applied to particulate, different fibers or fiber size distributions (inter).

Certain of these types of compounds may be defined by the following general formula:

M(R₁)ₙ(R₂)ₘ

wherein M is a central atom selected from such metals as, for example, Ti, Al, and Zr and other metal centers; R₁ is a hydrolysable group; R₂ is a group consisting of an organic moiety, preferably an organic group that is non-reactive with polymer or other film former; wherein the sum of m+n must equal the coordination number of the central atom and where n is an integer ≥1 and m is an integer ≥1. Particularly R₁ is an alkoxy group having less than 12 carbon atoms. Other useful groups are those alkoxy groups, which have less than 6 carbons, and alkoxy groups having 1-3 C atoms. R₂ is an organic group including between 6-30, preferably 10-24 carbon atoms optionally including one or more hetero atoms selected from the group consisting of N, O, S and P. R₂ is a group consisting of an organic moiety, which is not easily hydrolyzed and is often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic. R₂ is substantially unreactive, i.e. not providing attachment or bonding, to other particles or fiber within the composite material. Titanates provide antioxidant properties and can modify or control cure chemistry.

The use of an interfacial modifier results in workable thermoplastic viscosity and improved structural properties in a final use such as a structural member or shaped article. Minimal amounts of the modifier can be used including about 0.005 to 8 wt.-%, about 0.01 to 6 wt.-%, about 0.02 to 5 wt.-%, or about 0.02 to 3 wt. % based on the dispersed phase. The IM coating can be formed as a coating of at least 3 molecular layers or at least about 50 or about 100 to 500 or about 100 to 1000 or about 100 to 1500 angstroms (Å). The claimed composites with increased loadings can be safely compounded and melt processed formed into high strength structural members. The interfacial modification technology depends on the ability to isolate the surface of the dispersed phase from the continuous polymer phase. The isolation is obtained from a continuous molecular layer(s) of interfacial modifier to be distributed over the surface. From another perspective, the IM coated dispersed phase is immiscible in the polymer phase. Once this layer is applied, the behavior at the interface of the interfacial modifier to polymer dominates and defines the physical properties of the composite and the shaped or structural article (e.g. modulus, tensile, rheology, packing fraction and elongation behavior) while the bulk nature of the dispersed phase dominates the bulk material characteristics of the composite (e.g. density, thermal conductivity, compressive strength). The correlation of dispersed phase bulk properties to that of the final composite is especially strong due to the high-volume percentage loadings of discontinuous phase, such as particulate, fiber, associated with the technology.

The dispersed phase components are coated with IM to obtain the processing and physical properties needed. Once coated, the coating exterior appears to be the IM composition while the particulate or fiber composition such as a silica or silicate character is hidden. The organic nature of the coating changes the nature of the interaction between the surface and the polymer phase. The silicate or silica surfaces of the fibers are of a different surface energy and hydrophobicity than the polymer or coating. The polymer does not easily associate with the inorganic surface, but much more easily associates with the organic nature of the coated surface. The coated fiber mixes well with the polymer and can achieve greater composite uniformity and dispersed phase loadings.

The benefit of interfacial modification on a fully coated dispersed phase is independent of overall size or shape. The current upper limit constraint is associated with challenges of successful dispersion of dispersed phase within laboratory compounding equipment without significantly damaging the polymer or high aspect ratio fibers. Furthermore, inherent rheological challenges are associated with high aspect ratio fibers. With proper engineering, the ability to successfully compound and produce interfacially modify fibers of fiber fragments with aspect ratio more than 20 often in excess of 100, 200 or more is provided.

For composites containing high volumetric loading, the rheological behavior of the highly packed composites depends on the characteristics of the contact points between the dispersed particles. When forming composites with polymeric volumes approximately equal to the excluded volume of the discontinuous phase, inter-fiber interaction dominates the behavior of the material. Particles contact one another and the combination of interacting sharp edges, soft surfaces (resulting in gouging) and the friction between the surfaces prevent further or optimal packing. Interfacial modifying chemistries can alter the surface of the fiber by coordination bonding, Van der Waals forces, or a combination. The surface of the interfacially modified material behaves as an object of the non-reacted end or non-reacting end of the interfacial modifier. The coating of the interfacial modifier improves surface wetting by the polymer and as a result improves the physical association of the dispersed and polymer in the formed composite leading to improved physical properties including, but not limited to, increased tensile and flexural strength, increased tensile and flexural modulus, improved notched IZOD or Gardner impact results and reduced coefficient of thermal expansion. In the melt, the interfacial modified coating on the fiber reduces the friction between fibers thereby preventing gouging and allowing for greater freedom of movement between fibers in contrast to fibers that have not been coated with interfacial modifier chemistry. Thus, the composite can be melt-processed at greater productivity and at conditions of reduced temperature and pressure severity. The process and physical property benefits of utilizing the coated fibers in the acceptable fiber morphology index range does not become evident until packing to a significant proportion of the maximum packing fraction; this value is typically greater than approximately 50, 60, 70, 80, 90, 92 or 95 volume or weight % of the fiber phase in the composite.

In a composite, the dispersed phase is usually much stronger and stiffer than the polymer matrix and gives the composite its designed structural or shaped article properties. The polymer matrix holds the dispersed phase in an orderly high-density pattern. Because the dispersed phase is are usually discontinuous, the matrix also helps to transfer load among the non-metal, inorganic, synthetic, natural, or mineral components. Processing can aid in the mixing and filling of the non-metal, inorganic or mineral fibers. An interfacial modifier (IM) is an organic material that provides an exterior coating on the dispersed phase promoting the close association of polymer and dispersed phase. Minimal amounts of the interfacial modifier can be used on regular morphology while higher amounts of the IM are used to coat materials with increased or irregular surface morphology. Typically, the composite materials can be manufactured using melt processing and are also utilized in product formation using melt processing such as extrusion, injection molding and the like.

To interfacially modify, an interfacial modifier (IM) is directly contacted in solid/solid contact with the component(s) of the dispersed phase. Alternatively, the IM first solubilized with a solvent such as IPA. The solvent/modifier mixture is applied to a particulate or fiber portion previously placed within a preparation vessel. The solvent/modifier mixture is added in enough volume to fully wet or flood the material. The outer part of vessel is then heated to volatize the solvent. After an enough time, the modified material becomes free flowing—an indication that they are free of solvent fully coated and ready for compounding and thermoplastic processing. The extruded or injection molded member can be formed as a linear member or a hollow profile.

The improved process viscosity can be seen in comparing the processing of a composite as claimed compared to a composite of uncoated material. The claimed materials have substantially reduced processing viscosity that is derived from the freedom of movement of the interfacially modified dispersed phase within the polymer matrix. IM use also provides some dispersed phase self-ordering which increases packing fraction without the loss of rheology or breakage. We used a C. W. Brabender Computerized Plasti-Corder test mixer equipped with a 19.1 mm. (¾ in.) diameter extruder with a 25/1 length/diameter ratio. The extrusion screw had ten feed flights, 10 compression flights with a compression ratio of 3:1, and 5 metering flights. Operating parameters were controlled by 5 independent heating zones, four pressure transducers and a torque-measuring drive unit. Software module was used for extrusion data. The capillary die, made from #416 stainless steel, had a diameter of 2 mm and a length of 40 mm. In operation, the operating conditions were set, and the blended/polymer composite was then extruded until equilibrium (constant throughput and constant die pressure) were reached. Extrusion at 40 rpm and a die pressure of about 28 Mpa were used. Brabender viscosity is reported as torque according to the appropriate ASTM protocol in N-m. The linear member can be in the form of dimensioned lumber, trim pieces, circular cross-section rod, I-beam, etc. The profile comprises an exterior wall or shell substantially enclosing a hollow interior. The interior can contain structural web providing support for the walls and can contain one fastener anchor.

The composite, thus, obtains improved physical properties including at least one of, but not limited to, notched IZOD impact strength (ft-lb-in⁻¹) (ASTM D256), tensile strength (lb-in²), modulus (lb.×10⁶-in⁻²) and elongation (%) (ASTM D638/D3039) flexural strength (lb-in²) and modulus (lb.×10⁶-in⁻²) at elevated temperature (ASTM 790), or coefficient of thermal expansion (in-in⁻¹-° C.) (COTE-ASTM 696). Such properties are seen over a range of environmental temperatures.

A useful silicate fiber is a calcium meta silicate known as wollastonite, a natural CaSiO₃ often containing small amounts of iron, magnesium and manganese. The mineral can be represented as compositions including CaSiO₃—MgSiO₃—FeSiO₃ with the iron and magnesium components in minor proportions. Wollastonite is crystalline with chains of bonded SiO₃ tetrahedra. Wollastonite is commonly used in ceramics, tiles, paints compositions. Wollastonite has been proposed as a substitute for asbestos in a variety of products but its unique inorganic nature has limited its applicability in thermoplastic composites. The surface energy and hydrophobic nature of the wollastonite particulate or fiber surface severely limits commercial manufacture due to resulting poor melt polymer mixing, minimal packing and nonuniform composites. The use of a densified material can increase the process characteristics of the material and obtain improved product uniformity and physical properties. Without a uniform composite, the compounding processing and resulting mechanical properties can be lacking.

The silicate material has a density of about 2.5 to 3 or about 2.9 g·cc⁻¹ Each of the individual fibers of the generic, useful fiber material has a cross-section dimension (preferably but not limited to a diameter) of at least about 0.8 micron often about 1-150 microns and can be 2-100 microns, or 5 to 10 microns, a length of 0.1-150 mm, often 0.2-100 mm, and often 50 to 100 mm and can have an aspect ratio of at least 90 often about 100-1500.microns a surface area of 0.2 to 3 m²-g⁻¹, often 0.5 to 2 m²-g⁻¹.

The particulate in the composite of the invention has a range of particle sizes such that the particulate ranges from about 5 microns to 1000 microns. About at least 5 wt.-% of particulate is in the range of about 10 to 500 microns and about at least 5 wt.-% of particulate in the range of about 10 to 250 microns. The composite can have a Vander Waals' dispersion bond strength between adjacent particles of less than about 4 kJ-mol⁻¹ and a bond dimension of 1.4 to 1.9 A or less than about 2 kJ-mol⁻¹ or the van der Waals' bond dimension is about 1.5 to 1.8 A.

In a composite, the non-metal, inorganic or mineral particle is usually much stronger and stiffer than the matrix and gives the composite its designed properties. The matrix holds the non-metal, inorganic or mineral particles in an orderly high-density pattern. Because the non-metal, inorganic or mineral particles are usually discontinuous, the matrix also helps to transfer load among the non-metal, inorganic or mineral particles. Processing can aid in the mixing and filling of the non-metal, inorganic or mineral particle. To aid in the mixture, a surface chemical reagent can help to overcome the forces that prevent the matrix from forming a substantially continuous phase of the composite. The tunable composite properties arise from the intimate association obtained by use of careful processing and manufacture. We believe a surface chemical reagent is an organic material that provides an exterior coating on the particulate promoting the close association of polymer and particulate. Minimal amounts of the interfacial modifier chemical treatment can be used including about 0.005 to 3 wt.-%, or about 0.02 to 2 wt. %. One important inorganic material that can be used as a particulate in the invention includes ceramic materials. Ceramics are typically classified into three distinct material categories, including aluminum oxide and zirconium oxide ceramics, metal carbides, metal borides, metal nitrides, metal silicide, and ceramic material formed from clay or clay-type sources. Examples of useful technical ceramic materials are selected from barium titanate, boron nitride, lead zirconate or lead tantalite, silicate aluminum oxynitrides, silicane carbide, silicane nitride, magnesium silicate, titanium carbide, zinc oxide, zinc dioxide (zirconia) particularly useful ceramics of use in this invention comprise the crystalline ceramics and most preferred in compositions of the invention are the silica aluminum ceramics that can be made into useful particulate. Such ceramics are substantially water insoluble and have a particle size that ranges from about 10 to 500 microns, has a density that ranges from about 1.5 to 3 gm-cm⁻³ and are commonly commercially available. One useful ceramic product is the 3M ceramic microsphere materials such as g-200, g-400, g-600, g-800 and g-850.

Optional fiber useful can be inorganic or organic and can be natural or synthetic. Synthetic fibers are generally derived from petrochemical sources and are often made of polymer materials. Such polymers include nylon, polyester, PVC, polyolefin, acrylic, aramid, urethane etc. Other fibers include metallic fiber, carbon fiber, mineral fiber, wood fiber, cellulosic, fiber and others.

One useful fiber is a silica glass fiber. Silica forms a useful fiber and comprises a glass fiber known by the designations: A, C, D, E, Zero Boron E, ECR, AR, R, S, S-2, N, and the like. Generally, any glass that can be made into fibers either by drawing processes used for making reinforcement fibers or spinning processes used for making thermal insulation fibers. Such fiber is typically used as a length of about 0.8-100 microns often about 2-100 microns, a diameter about 0.8-100 microns and an aspect ratio (length divided by diameter) greater than 90 or about 100 to 1500. These commercially available fibers are often combined with a sizing coating. Such coatings cause the otherwise ionically neutral glass fibers to form and remain in bundles or fiber aggregates. Sizing coatings are applied during manufacture before gathering. The sizing minimizes filament degradation caused by filament to filament abrasion. Sizings can be lubricants, protective, or reactive couplers but do not contribute to the properties of a composite using an interfacial modifier (IM) coating on the fiber surface. Sizings are not interfacial modifiers.

A large variety of thermoplastic polymer and copolymer materials can be used in the composite materials. We have found that polymer materials useful in the composite include both condensation polymeric materials and addition or vinyl polymeric materials.

Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water, methanol or some other simple, typically volatile substance. Such polymers can be formed in a process called polycondensation. The typical polymer has a density of at least 0.85 gm-cm⁻³, however, polymers having a density of greater than 0.96 are useful to enhance overall product density. A density is often 0.94 to 1.7 or up to 2 gm-cm⁻³ or can be about 0.96 to 1.95 gm-cm⁻³.

Vinyl polymers include polyacrylonitrile; polymer of alpha-olefins such as ethylene, propylene, etc.; polymers of chlorinated monomers such as vinyl chloride, vinylidene chloride, acrylate monomers such as acrylic acid, methyl acrylate, methyl methacrylate, acrylamide, hydroxyethyl acrylate, and others; styrenic monomers such as styrene, alpha-methyl styrene, vinyl toluene, etc.; vinyl acetate; and other commonly available ethylenically unsaturated monomer compositions. Examples include polyethylene, polypropylene, polybutylene, acrylonitrile-butadiene-styrene (ABS), polybutylene copolymers, polyacetal resins, polyacrylic resins, homopolymers, etc. Useful polymers are halogen polymers such as homopolymers, copolymers, and blends comprising vinyl chloride, vinylidene chloride, fluorocarbon monomers, etc. Polyvinyl chloride polymers with a K value of 50-75 can be used. A characteristic of the PVC resin is the length or size of the polymer molecules. A measure of the length or size is molecular weight of PVC. A useful molecular weight can be based on measurements of viscosity of a PVC solution. Such a K value ranges usually between 35 and 80. Low K-values imply low molecular weight (which is easy to process but has properties consistent with lower polymer size) and high K-values imply high molecular weight, (which is difficult to process, but has properties consistent with polymer size). The most commonly employed molecular characterization of PVC is to measure the one-point-solution viscosity. Expressed either as inherent viscosity (IV) or K-value, this measurement is used to select resins for the use in extrusion, molding, as well as for sheets, films or other applications. The inherent viscosity (IV) or K-value is the industry standard (ISO 1628-2) starting point for designing compounds for end use. Polymer solution viscosity is the most common measurement for further calculation of inherent viscosity or the K-value, because it is an inexpensive and routine procedure that can be used in manufacturing as well as in R&D labs. For example, a Lovis® 2000 M/ME micro-viscometer can measure polymer solution viscosity and set K value.

Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials. Condensation polymers that can be used in the composite materials include polyamides, polyamide-imide polymers, polyarylsulfones, polycarbonate, polybutylene terephthalate, polybutylene naphthalate, polyetherimides, polyether sulfones, polyethylene terephthalate, thermoplastic polyamides, polyphenylene ether blends, polyphenylene sulfide, polysulfones, thermoplastic polyurethanes and others. Preferred condensation engineering polymers include polycarbonate materials, polyphenyleneoxide materials, and polyester materials including polyethylene terephthalate, polybutylene terephthalate, polyethylene naphthalate and polybutylene naphthalate materials.

Polymer blends or polymer alloys can be useful in manufacturing the claimed pellet or linear extrudate. Such alloys typically comprise two miscible polymers blended to form a uniform composition. Scientific and commercial progress in the area of polymer blends has led to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon enough cooling and a homogeneous or miscible polymer blend exhibits a single, composition dependent glass transition temperature (T_{g}). Immiscible or non-alloyed blend of polymers typically displays two or more glass transition temperatures associated with immiscible polymer phases. In the simplest cases, the properties of polymer alloys reflect a composition-weighted average of properties possessed by the components. In general, however, the property dependence on composition varies in a complex way with a property, the nature of the components (glassy, rubbery or semi-crystalline), the thermodynamic state of the blend, and its mechanical state whether molecules and phases are oriented.

The primary requirement for the substantially thermoplastic engineering polymer material is that it retains enough thermoplastic properties such as viscosity and stability, to permit melt blending with a dispersed phase, permit formation of linear extrudate pellets, and to permit the composition material or pellet to be extruded or injection molded in a conventional thermoplastic process forming the useful product. Engineering polymer and polymer alloys are available from several manufacturers including Dyneon LLC, B.F. Goodrich, G.E., Dow, and duPont.

There are two key attributes of the surface coating that dictate the ability to be successfully interfacially modified: 1) the overall surface area of dispersed phase; and 2) dispersed phase surface characteristics that are on the order of the molecular size of the interfacial modifier being applied.

Sizing materials used as glass fiber or particle coatings do not act as interfacial modifiers. Sizing is an essential in glass fiber manufacture and critical to maintain glass integrity. Sizings aid in fibers integrity during manufacturing and use. Raw fibers are abrasive and easily abraded and reduced in size and length. Without sizing, fibers can be reduced to useless “fuzz” during processing. Sizing formulations have been used by manufacturers to distinguish their glass products from competitors' glass products. Glass fiber sizing, typically, is a mixture of several chemistries each contributing to sizing performance on the glass fiber surface. Sizings typically are manufactured from film forming compositions and reactive coupling agents. Once formed, the combination of a film forming material and a reactive coupler forms a reactively coupled film that is, reactively coupled to the glass fiber surface. The sizing protects the fiber, holding fibers together prior to molding but promote dispersion of the fiber when coming into contact with polymer or resin insuring wet out of glass fiber with resin during composite manufacture. Typically, the coupling agent used with the film forming agent, is a reactive alkoxy silane compound serving primarily to bond the glass fiber to their matrix or film forming resin. Silane typically have a silicon containing group and that bonds well to glass (typically SiO₂) with a reactive organic end that bonds well to film forming polymer resins. Sizings also may contain additional lubricating agents as well as anti-static agents. We have used sized fibers in our studies and found that sizing does not act as interfacial modifier and we can coat all sizing that we have found. While a sizing often contains coupling agents, an IM is free of coupling or reactive coupling agents.

In a composite, the fiber is usually much stronger and stiffer than the polymer matrix and gives the composite its designed structural or shaped article properties. The matrix holds the fiber in an orderly high-density pattern. Because the fibers are usually discontinuous, the matrix also helps to transfer load among the non-metal, inorganic, synthetic, natural, or mineral fibers.

Typically, the composite materials can be manufactured using melt processing and are also utilized in product formation using melt processing. A typical thermoplastic polymer material is combined with IM coated blend and processed until the material attains (e.g.) a uniform density (if density is the characteristic used as a determinant). Alternatively, in the manufacture of the material, the dispersed phase or the thermoplastic polymer may be blended with interfacial modification agents and the modified materials can then be melt processed into the material. Once the material attains a sufficient property, such as, for example, density, the material can be extruded into a product or into a raw material in the form of a pellet, chip, wafer, preform or other easily processed material using conventional processing techniques.

In the manufacture of useful products, the manufactured composite can be obtained in appropriate amounts, subjected to heat and pressure, typically in an extruder, or in additive manufacturing useful for 3D printing (additive manufacturing), or injection molding equipment and then formed into an appropriate shape having the correct amount of materials in the appropriate physical configuration. In the appropriate product design, during composite manufacture or during product or article manufacture, a pigment or other dye material can be added to the processing equipment. One advantage of this material is that an inorganic dye or pigment can be co-processed resulting in a material that needs no exterior painting or coating to obtain an attractive, functional, or decorative appearance. The pigments can be included in the polymer blend, can be uniformly distributed throughout the material and can result in a surface that cannot chip, scar or lose its decorative appearance. One particularly important pigment material comprises titanium dioxide (TiO₂). This material is non-toxic, is a bright white particulate that can be easily combined with the fiber and/or polymer composites to enhance the novel characteristics of the composite material and to provide a white hue to the ultimate composite material.

The manufacture of the composite materials depends on good melt processing manufacturing technique. The dispersed phase is initially treated with an interfacial modifier by contacting the dispersed phase with the modifier directly or in the form of a solution of interfacial modifier with blending and drying carefully to ensure uniform fiber coating. Interfacial modifier can also be added in bulk blending operations using high intensity Littleford or Henschel blenders. Alternatively, addition of the dispersed phase blend to the twin cone mixers can be followed by drying or direct addition to a screw compounding device. Interfacial modifiers may also be combined with the fiber blend in aprotic solvent such as toluene, tetrahydrofuran, mineral spirits or other such known solvents.

The dispersed phase blend can be combined into the polymer phase depending on the nature of the polymer phase, the surface chemistry of the dispersed phase and any pigment process aid or additive present in the composite material. The composite materials having the desired physical properties can be manufactured as follows. In an embodiment, the surface is initially prepared, the interfacial modifier coats the dispersed phase, and the resulting IM coated blend is isolated and then combined with the continuous polymer phase to affect an immiscible dispersion or association between the dispersed phase and the polymer. Once the composite material is compounded or prepared, it is then melt-processed into the desired shape of the end use article.

Solution processing is an alternative that provides solvent recovery during materials processing. The materials can also be dry-blended without solvent. Blending systems such as ribbon blenders obtained from Drais Systems, high-density drive blenders available from Littleford Brothers and Henschel are possible. Further melt blending using Banberry, other single screw or twin-screw compounders is also useful. When the materials are processed as a plastisol or organosol with solvent, liquid ingredients are generally charged to a processing unit first, followed by polymer and rapid agitation. Once all materials are added a vacuum can be applied to remove residual air and solvent, and mixing is continued until the product is uniform and high in density.

Dry blending of components before melt processing is generally preferred due to advantages in cost. However certain embodiments can be compositionally unstable due to differences in materials sizes. In dry blending processes, the composite can be made by first introducing the polymer, combining the polymer stabilizers, if necessary, at a temperature from about ambient to about 60° C. with the polymer, blending with the stabilized polymer, blending other process aids, interfacial modifier, colorants, indicators or lubricants followed by mixing in hot mix, transfer to storage, packaging or end use manufacture.

The composite can be used to make a pellet. Such a pellet made of the composite can be used as an intermediate between the compounding of the composite and the manufacturing of the final product. Such a pellet can comprise the composite comprising the components in use concentration of components designed to be directly converted or used in making a useful article. Alternatively, the pellet can comprise a master batch composition with increased amounts, e.g., about 2 to 10 times the amount of fiber such that the pellet can be combined with polymer in proportions that result in producing use concentrations. The pellet is a roughly cylindrical object that can be fed into an extruder input. The pellet is typically 1 to 100 mm in height and 1 to 20 mm in diameter and weighs about 10 to 100 mg or 20 to 80 mg.

The composite can be used to make an article of manufacture. Such articles can be made directly from the compounding process or can be made from a pellet input. Articles can include pellets used in further thermoplastic processing, structural members, or other articles that can be made using thermoplastic processing such as injection molding, compression molding, etc.

Structural members include linear extrudates that can be mechanically milled or reinforced with secondary members. The articles can be used in a fenestration unit as a frame member, muntin, grill etc. The articles can be used in a decking installation as a decking member, a trim, or a support. The article can be used as a rail, baluster or post. The article can be used as a siding member.

The interior of the structural member is commonly provided with one or more structural webs which in a direction of applied stress supports the structure. Structural web typically comprises a wall, post, support member, or other formed structural element which increases compressive strength, torsion strength, or other structural or mechanical properties. Such structural web connects the adjacent or opposing surfaces of the interior of the structural member. More than one structural web can be placed to carry stress from surface to surface at the locations of the application of stress to protect the structural member from crushing, torsional failure or general breakage. Typically, such support webs are extruded, compression or injection molded during the manufacture of the structural material. However, a support can be post added from parts made during separate manufacturing operations.

The internal space of the structural member can also contain a fastener anchor or fastener installation support. Such an anchor or support means provides a locus for the introduction of a screw, nail, bolt or other fastener used in either assembling the unit or anchoring the unit to a rough opening in the commercial or residential structure. The anchor web typically is conformed to adapt itself to the geometry of the anchor and can simply comprise an angular opening in a formed composite structure, can comprise opposing surfaces having a gap or valley approximately equal to the screw thickness, can be geometrically formed to match a key or other lock mechanism, or can take the form of any commonly available automatic fastener means available to the window manufacturer from fastener or anchor parts manufactured by companies such as Amerock Corp., Illinois Tool Works and others.

The structural member can have extrusion molded, premolded paths or paths machined into the molded thermoplastic composite for passage of door or window units, fasteners such as screws, nails, etc. Such paths can be counter sunk, metal lined, or otherwise adapted to the geometry or the composition of the fastener materials. The structural member can have mating surfaces formed to provide rapid assembly with other window components. Components of similar or different compositions having similarly adapted mating surfaces. Further, the structural member can have mating surfaces formed in the shell of the structural member adapted to moveable window sash or door sash or other moveable parts used in window operations.

The structural member can have a mating surface adapted for the attachment of the subfloor or base, framing studs or side molding or beam, top portion of the structural member to the rough opening. Such a mating surface can be flat or can have a geometry designed to permit easy installation, sufficient support and attachment to the rough opening. The structural member shell can have other surfaces adapted to an exterior trim and interior mating with wood trim pieces and other surfaces formed into the exposed sides of the structural member adapted to the installation of metal runners, wood trim parts, door runner supports, or other metal, plastic, or wood members commonly used in the assembly of windows and doors.

The assembly can use known fastener techniques. Such techniques include screws, nails, and other hardware. The structural members can also be joined by an insert into the hollow profile, glue, or a melt fusing technique wherein a fused weld is formed at a joint between two structural members. The structural members can be cut or milled to form conventional mating surfaces including 90° angle joints, rabbit joints, tongue and groove joints, butt joints, etc. Such joints can be bonded using an insert placed into the hollow profile that is hidden when joinery is complete. Such an insert can be glued or thermally welded into place. The insert can be injection molded or formed from similar thermoplastics and can have a service adapted for compression fitting and secure attachment to the structural member. Such an insert can project from approximately 1 to 5 inches into the hollow interior of the structural member. The insert can be shaped to form a 900 angle, a 180° extension, or other acute or obtuse angle required in the assembly of the structural member.

Further, such members can be manufactured by milling the mating faces and gluing members together with a solvent, structural or hot melt adhesive. Solvent borne adhesives that can act to dissolve or soften thermoplastic present in the structural member and to promote solvent based adhesion or welding of the materials are known in polyvinyl chloride technology. In the welding technique, once the joint surfaces are formed, the surfaces of the joint can be heated to a temperature above the melting point of the composite material and while hot, the mating surfaces can be contacted in a configuration required in the assembled structure. The contacted heated surfaces fuse through an intimate mixing of molten thermoplastic from each surface. Once mixed, the materials cool to form a structural joint having strength typically greater than joinery made with conventional techniques. Any excess thermoplastic melt that is forced from the joint area by pressure in assembling the surfaces can be removed using a heated surface, mechanical routing or a precision knife cutter.

TABLE 1
Exemplary Particulate/Silicate Fiber Composites

| | Useful | Useful | Useful |
|---|---|---|---|
| Component | amounts | amounts | amounts |
| Particle (vol. %) | 5-95 | 10-90 | 15-85 |
| Silicate fiber (vol. %) | 5-60 | 8-50 | 10-45 |
| Particle (wt. %) | 5-95 | 10-90 | 15-85 |
| Silicate (wt. %) | 10-75 | 15-70 | 20-65 |
| Interfacial modifier | 0.1-5 | 0.3-3 | 0.5-2.5 |
| coating (Vol. %) | | | |
| Interfacial modifier | 0.1-2 | 0.2-1 | 0.3-0.8 |
| coating (Wt. %) | | | |
| Thermoplastic | 45-95 | 50-92 | 55-90 |
| polymer (vol. %) | | | |
| Thermoplastic | 20-90 | 30-85 | 35-80 |
| polymer (wt. %) | | | |

TABLE 2
Exemplary Composites - Wollastonite with Glass Fiber

| | Useful | Useful | Useful |
|---|---|---|---|
| Component | amounts | amounts | amounts |
| Glass Fiber (vol. %) | 5-95 | 10-90 | 15-85 |
| Wollastonite (vol. %) | 5-60 | 8-50 | 10-45 |
| Glass Fiber (wt. %) | 5-95 | 10-90 | 15-85 |
| Wollastonite (wt. %) | 10-75 | 15-70 | 20-65 |
| Interfacial modifier | 0.1-5 | 0.3-3 | 0.5-2.5 |
| coating (Vol. %) | | | |
| Interfacial modifier | 0.1-2 | 0.2-1 | 0.3-0.8 |
| coating (Wt. %) | | | |
| Thermoplastic | 45-95 | 50-92 | 55-90 |
| polymer (vol. %) | | | |
| Thermoplastic | 20-90 | 30-85 | 35-80 |
| polymer (wt. %) | | | |

With an IM, either of the composites can achieve the following properties:

TABLE 3
Typical property ranges

| | ASTM | Minimum | Range of | |
|---|---|---|---|---|
| Properly | Method | Value | Value | Units |
| Tensile | D638 | 35 (2) | >35 | MPa (kpsi) |
| Strength | | | 2.5 to 20 | |
| Tensile | D638 | 8 (0.5) | >4 | GPa (Mpsi) |
| Modulus | | | 0.7 to 2.75 | |
| Flexural | D790 | 35 (2) | >35 | MPa (kpsi) |
| Strength | | | 2.5 to 20 | |
| Flexural | D790 | 8 (0.5) | >4 | GPa (Mpsi) |
| Modulus | | | 0.7 to 2.75 | |
| Notched | D256 | 70 (0.4) | 0.5-3 | J · m⁻¹ |
| IZOD | | | | (ft · lbs · in⁻¹) |
| COTE | D696 | Maximum Value: | — | cm · cm⁻¹° C. |
| | | 1.9 × 10⁻⁵ | — | (in · in-¹⁰° F.) |
| | | (1.1 × 10⁻⁵) | 2 × 10⁻⁶ | |
| | | | to 2 × 10⁻⁵ | |

Additionally, the use of the IM permits an increase in the loading in the composite. As the dispersed phase content increases, the polymer content decreases. The thermal expansion of a structural member made with the disclosed material will be improved as dispersed phase content increases, e.g., the material will have reduced coefficient of thermal expansion (COTE).

### EXPERIMENTAL SECTION

### Example 1-10

In a compounder, a pellet was extruded at using conventional thermoplastic compounding rates using IM coated particulates (organo titanate, 1 wt. %) and then extruded into test piece(s) for physical testing as shown below using the proportions as follows:

TABLE 4
Formulations

| Material | | Wt. % | Vo. 1% | Wt. % | Vol. % | | | |
|---|---|---|---|---|---|---|---|---|
| Example | Glass | Wollastonite | Wollastonite | Glass | Glass | Wt. % | Vol. % | |
| No. | beads | Fiber | Fiber | beads | beads | solids | solids | g/cc |
| 1 | None | 7% | 4% | 0% | 0% | 7% | 4% | 1.48 |
| 2 | None | 37% | 23% | 0% | 0% | 37% | 23% | 1.76 |
| 3 | None | 70% | 53% | 0% | 0% | 70% | 54% | 2.22 |
| 7 | Glass | 36% | 22% | 10% | 7% | 46% | 31% | 1.80 |
| | Beads | | | | | | | |
| 8 | Glass | 12% | 8% | 32% | 23% | 44% | 31% | 1.74 |
| | Beads | | | | | | | |
| 9 | Glass | 54% | 39% | 15% | 13% | 69% | 54% | 2.13 |
| | Beads | | | | | | | |
| 10 | Glass | 19% | 13% | 49% | 39% | 68% | 55% | 2.00 |
| | Beads | | | | | | | |

TABLE 5
properties of composites of Examples 1-10

| | | | | | IZOD Impact | | |
|---|---|---|---|---|---|---|---|
| | Tensile Testing | | Flex Testing | | Strength | Thermal Properties | |
| | Test | | | | | | |
| | Max | | Max | | Notched | | Heat Deflection |
| | Tensile | Tensile | Flexural | Flexural | Impact | | Temperature |
| | Stress | Modulus | Strength | Modulus | Strength | COTE | (264 PSI) |
| Material | Parameter | | | | | | |
| Example No. | psi | Mpsi | psi | Mpsi | ft-lbf-in⁻² | in/in ° C. | ° C. |
| 1 | D638 | D638 | D790 | D790 | D256 | D696 | D648 |
| 2 | 4796 | 0.50 | 8532 | 0.42 | 1.5 | 4.97E−05 | 66.4 |
| 3 | 4011 | 1.17 | 8256 | 1.35 | 2.4 | 2.44E−05 | 68.6 |
| 7 | 2979 | 1.25 | 6437 | 1.36 | 3.0 | 2.38E−05 | 68.9 |
| 8 | 2257 | 0.71 | 5281 | 0.75 | 2.1 | 3.71E−05 | 67.0 |
| 9 | 1457 | 1.43 | 3093 | 1.48 | 1.9 | 1.69E−05 | 68.4 |
| 10 | 1208 | 1.11 | 2800 | 1.12 | 2.0 | 2.51E−05 | 67.6 |

### Example 11a

Polyvinyl chloride homopolymer, Formolon® AWS16 (Formosa, Livingston, N.J.) in an amount of 69 vol. % (53 wt. %) was combined with an IM coated fiber (organo titanate, 0.88 vol. %, 0.46 wt. %) wollastonite fiber, length 65 μm and diameter 7 μm (HR2000, Vansil) in an amount of 30 vol. % (46 wt. %) and compounded into a pellet with dimensions of approximate length of 3 mm and approximate diameter of 5 mm. Comparative examples were made with glass fiber components.

### Comparative Example 11

Polyvinyl chloride homopolymer, Formolon® AWS16 (Formosa, Livingston, N.J.) in an amount of 68 vol. % (54 wt. %) combined with an IM coated fiber (organotitanate, 1.11 vol. %, 0.64 wt. %) of glass fiber (John Mansville, Starstran 718) in an amount of 29 vol. % (43 wt. %) and Ca CO₃ in an amount of 1 vol. % (2 wt. %) and compounded into a pellet with dimensions of approximate length of 3 mm and approximate diameter of 5 mm.

The Example and the comparative examples were tested using the appropriate test piece as follows in Table 6.

TABLE 6
testing results

| Property | Example 11a | Comp. Ex. 11 |
|---|---|---|
| Density (g-cc⁻¹) | 1.87 | 1.80 |
| Tensile strength (psi) | 3383 | 7413 |
| Tensile modulus (Mpsi) | 1.24 | 1.67 |
| Tensile elongation (%) | 1.4 | 0.75 |
| Flex strength (psi) | 7726 | 13285 |
| Flex modulus (Mpsi) | 1.33 | 1.97 |
| Heat distortion temp. (° C.) | 69 | 74 |
| COTE (in · in⁻¹° F.) | 1.4 × 10⁻⁵ | 1.1 × 10⁻⁵ |
| Notched IZOD | 1.6 | 2.2 |
| impact strength (ft. · lb.-in⁻²) | | |
| Un-notched IZOD | 13 | 3.73 |
| impact strength (ft. · lb.-in⁻²) | | |
| Supported drop | 14 (11) | 7 (18) |
| dart energy (J) at height (in) | | |
| Unsupported drop | 9.4 (11) | 5.2 (11.4) |
| dart energy (J) | | |

### Example 12

In a series of formulations of Polyvinyl chloride homopolymer, Formolon® AWS16 (Formosa, Livingston, N.J.) is combined with an IM coated fiber (1.5 vol. %, 1.5 wt. %, organo-titanate) comprising amounts of a hollow glass sphere diameter 20-60 μm and a wollastonite (Vansil® W-10), in an amount of 30 vol. % (46 wt. %) and compounded into a pellet with dimensions of approximate length of 3 mm and approximate diameter of 5 mm. The range of materials were tested, and test results were gathered for flex and notched IZOD and Gardner impact strength.

### Example 13

In a series of formulations of Polyvinyl chloride homopolymer, Formolon® AWS16 (Formosa, Livingston, N.J.) is combined with an IM coated wood flour (1.5 vol. %, 1.5 wt. %, organo-titanate) comprising amounts of a wood flour length 3.175 mm and diameter 13 μm and a wollastonite (Vansil® W-10), in an amount of 30 vol. % (46 wt. %) and compounded into a pellet with dimensions of approximate length of 3 mm and approximate diameter of 5 mm. The range of materials were tested, and test results were gathered for flex and notched IZOD and Gardner impact strength.

These data show that at an amount of wollastonite and glass and other particles can be equal to or exceeds a composite of wollastonite only in flex and notched IZOD impact strength. At amounts of wollastonite of 55 to 80 wt. %, the composite possesses enough physical integrity to satisfy the needs of a manufacture of construction units such as fenestration, siding and decking.

The claims may suitably comprise, consist of, or consist essentially of, or be substantially free or free of any of the disclosed or recited elements. The claimed technology is illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims.

While the above specification shows an enabling disclosure of the composite technology, other embodiments may be made with the claimed materials. Accordingly, the invention is embodied solely in the claims hereinafter appended.

We claim:

1. A thermoplastic composite comprising about 90 to 10 vol. % of a discontinuous phase dispersed in about 10 to 90 vol. % of a continuous polymer phase:
(a) the discontinuous phase comprising up to 95 wt. % of a fiber and a particulate, the fiber being about 8 to 50 wt. % of a CaSiO₃ fiber, the particulate being about 45 to 87 wt. % of, the discontinuous phase having about 0.1 to 5 wt. % of an exterior coating comprising an organometallic interfacial modifier, the wt. % based on the discontinuous phase; and
(b) the continuous polymer phase comprising a vinyl chloride polymer;
wherein the composite has an IZOD impact strength of greater than about 1.3 ft-lb-in⁻¹ (ASTM D256), a COTE of less than about 1.0×10⁻⁵ cm·cm⁻¹·° C. (ASTM 696), a tensile modulus (ASTM D638) of greater than 8 GPa, a flexural strength (ASTM D790) of greater than 35 MPa, a tensile strength (ASTM D638) of greater than 35 MPa and a flexural modulus (ASTM D790) of greater than 8 GPa.

2. The composite of claim 1 wherein the CaSiO₃ fiber comprises wollastonite.

3. The composite of claim 1 wherein the particle comprises wood.

4. The composite of claim 1 comprising about 15 to 50 vol. % discontinuous phase and about 50 to 85 vol. % continuous phase.

5. The composite of claim 1 wherein the polymer K value is about 35-80 (ISO 1628-2).

6. The composite of claim 1 wherein the organometallic interfacial modifier comprises a titanate compound.

7. The composite of claim 1 wherein the organometallic interfacial modifier is free of any reactive coupling agent.

8. The composite of claim 1 wherein the silicate comprises wollastonite fiber with a size of 3 to 15 microns diameter, 30 to 120 microns length and having about 0.1 to 5 wt. % of an exterior coating comprising an organotitanate interfacial modifier.

9. A pellet comprising a cylindrical object with a diameter of about 1 to 20 mm and a length of about 1 to 50 mm comprising the composition of claim 1.

10. A thermoplastic composite comprising about 70 to 25 vol. % of a discontinuous phase dispersed in about 30 to 75 vol. % of a continuous polymer phase:
(a) the discontinuous phase comprising up to 95 wt. % of a particulate and about 5 to 60 wt. % of a wollastonite fiber, the fibers and particulate having about 0.1 to 5 wt. % of an exterior coating comprising an organometallic interfacial modifier, the wt. % based on the discontinuous phase; and
(b) the continuous polymer phase comprising a vinyl polymer;
wherein the composite has a notched IZOD impact resistance of about 0.5 to 3.0 ft-lb-in⁻¹ (ASTM D256), a COTE of about 2×10⁻⁶ to 2×10⁻⁵ in·in⁻¹·° F. (ASTM 696), a tensile modulus (ASTM D638) of greater than 0.7 to 2.75 Mpsi at 72° F., a flexural modulus (ASTM D790) of greater than 0.7 to 2.7 Mpsi at 72° F., a flexural strength (ASTM D790) of 2.5 to 20 kpsi at 72° F., a tensile strength (ASTM D638) of 2 to 20 kpsi at 72° F.

11. The composite of claim 10 wherein the vinyl polymer comprises a vinyl chloride copolymer

12. A shaped article comprising the composite of claim 10 that can be extruded and reextruded

13. The shaped article of claim 12 wherein the article is a linear extrudate.

14. The article of claim 13 wherein the article is a fenestration unit, a siding member, a railing member, a trim member, or a decking member.

15. A thermoplastic composite comprising about 90 to 10 vol. % of a discontinuous fiber phase dispersed in about 10 to 90 vol. % of a continuous polymer phase:
(a) the discontinuous phase comprising up to 95 wt. % of a particulate and a fiber, the fiber being about 8 to 50 wt. % of a CaSiO₃ fiber, the particulate being about 87 to 45 wt. % having an aspect ratio less than 1:3, the discontinuous phase having about 0.1 to 5 wt. % of an exterior coating comprising an organometallic interfacial modifier, the wt. % based on the discontinuous phase; and
(b) the continuous polymer phase comprising a vinyl chloride polymer;
wherein the composite has a notched IZOD impact resistance of about 0.5 to 3.0 ft-lb-in⁻¹ (ASTM D256), a COTE of about 2×10⁻⁶ to 2×10⁻⁵ in·in⁻¹·° F. (ASTM 696), a tensile modulus (ASTM D638) of greater than 0.7 to 2.75 Mpsi at 72° F., a flexural modulus (ASTM D790) of greater than 0.7 to 2.7 Mpsi at 72° F., a flexural strength (ASTM D790) of 2.5 to 20 kpsi at 72° F., a tensile strength (ASTM D638) of 2 to 20 kpsi at 72° F.

16. The composite of claim 15 wherein the silicate fiber comprises a wollastonite fiber.

17. The composite of claim 15 wherein the particulate comprises an inorganic particulate.

18. The composite of claim 15 comprising about 16 to 65 vol. % of the discontinuous phase and about 35 to 84 vol. % of the continuous phase.

19. The composite of claim 15 wherein the melt index of the of the vinyl chloride polymer is about 40 to 80 min⁻¹ and the molecular weight (Wₙ) is about 20,000 to 72,000.

20. The composite of claim 15 wherein the about 0.1 to 2 wt.-% of an interfacial modifier.

21. The composite of claim 15 wherein the organometallic interfacial modifier comprises a titanate compound.

22. The composite of claim 15 wherein the organometallic interfacial modifier is free of any reactive coupling agent.

23. A pellet comprising a cylindrical object with a length of about 6.35 to 25.4 mm and a diameter of about 2.54 to 12.70 mm comprising the composition of claim 15.
